(19) United States
(12) Patent Application Publication
(10) Pub. No.: US 2016/0125542 A1
(43) Pub. Date: May 5, 2016

(54) Computer Assisted Magic Trick Executed in the Financial Markets

(71) Applicants: Simon Andreas Goldin, Stockholm (SE); Jakob Hannes Gustaf Senneby, Stockholm (SE); Malin Margareta Nilsson, Malmo (SE); Theo Bourgeron, Edinburgh (GB)

(72) Inventors: Simon Andreas Goldin, Stockholm (SE); Jakob Hannes Gustaf Senneby, Stockholm (SE); Malin Margareta Nilsson, Malmo (SE); Theo Bourgeron, Edinburgh (GB)

(21) Appl. No.: 14/994,206

(22) Filed: Jan. 13, 2016

(51) Int. Cl. G06Q 40/06; G06Q 40/04

(52) U.S. Cl. CPC G06Q 40/06; G06Q 40/04

(57) ABSTRACT

The invention is directed toward a method of performing an unconventional magic trick. The magic trick is a methodology of identifying a number of securities of publicly traded companies which are ideal targets for short selling. The process starts with utilizing a computer system to scrape publicly available information on the internet about a company. The system then searches for social connections between a target company and a company which has been previously successfully targeted for a short selling campaign. Evidence which would cause a change in the perceived value is collected and disseminated. A magic show is performed where the perceived value of the target company is first increased and then sharply decreased. Audience members are invited to participate in the trick by purchasing enhanced tickets which include a share in the proceeds from a short selling campaign against the company.

### FIELD OF THE INVENTION

This invention pertains generally to automated investment and more particularly to a computer assisted magic trick in which a computer is utilized in selecting a specific security for short selling and implementing a change in perception regarding a specific security.

### BACKGROUND OF INVENTION

There are several types of investment securities, including stocks and bonds. These securities are property rights which can be bought and sold by individuals. An individual can buy a security at a low price, hold it for a period of time until the value of the security rises, and then sell the security for a profit. In addition, if an individual believes that the value of a security is overvalued, the individual can short-sell that security by selling the security prior to owning it, waiting for the value of the security to lower, and then purchasing the security at a later time.

Short selling is a fundamental market activity that goes as far back as the first stock. Short selling can be used for a variety of purposes, but in this context we are only concerned with speculative short selling, aiming to generate a profit in absolute terms from the downward movement of the underlying security.

In theory short selling should help keep market prices close to some measure of “fair value”, but there is substantial literature on predatory trading and manipulation showing that short selling equally can move prices away from fair value. Some economists go as far as to characterize shorting techniques as “weapons,” arguing that hedge funds are not just active traders, but active manipulators of those trades, when the goal is to ‘make the positions work.’ Among speculative short sellers there are a number of approaches for identifying short targets including quantitative analysis, forensic accounting, thematic investing, identifying balance sheet weakness, and understanding market ecology. Manipulative short selling is not just a question of identifying the right target, but also includes “making positions work”. Some short sellers are very public in their attacks on target companies, but as others have experienced this can prove risky.

Making a position work is similar to techniques found in “magic.” “Magic” in this context is defined as method for directing people's attention and manipulating their perception of reality. A standard magic trick can be broken down to three parts. In the first part the magician shows an ordinary object to the audience. In the second part the magician makes the ordinary object behave in an unusual manner. In the third part the magician changes to object back to ordinary. In this instance, the magic trick begins before the show when the audience member purchases an enhanced ticket (an ordinary object), is developed during the show when it is understood in relation to magic effects such as transformation of value, transmission of thought and prediction of the future (the ordinary object behaves magically), and is realized after the show when the money is received and the effect on the market is objectively verifiable (the item turns back into an ordinary object).

The invention can be understood as being in the vein of “conspiracy magic.” “Conspiracy magic” is defined as the use of illusionist methods to intervene in “offstage reality”. This is magic operating beyond the purposes of entertainment. “Conspiracy magic” has been performed in many different manners in the past. For instance, magic tricks and techniques have also been used in warfare and military intelligence work. Legendary stage magician Jean-Eugène Robert-Houdin was enlisted by the French army in 1856 to pacify local tribes in French Algeria using magic. In the 1950's, American magician John Mulholland developed a manual on trickery and deception for the CIA as part of their notorious MKULTRA program exploring the tactical use of hallucinogens and other experimental drugs in the context of the cold war.

More closely related to “conspiracy magic” with regard to short selling securities is the process of manipulating the value of the security by circulating negative information about target companies without revealing oneself as the source. Gotham City Research has provided some of the most scathing reports on short targets, while trader Daniel Yu (supposedly linked to Gotham City) keeps a very low profile. Short-only hedge fund Kingsford Capital Management keeps an even lower profile, but is surrounded by rumors about journalists, online financial analysts and law firms helping to realize its short positions.

Beyond anecdotal information, little is known about the details of short selling strategies. Such details are usually the trade secrets of hedge funds and other institutional investors, and only circulate within a small community of professional traders. The fact that there is no requirement to report short positions to the SEC (and only limited such requirements in other jurisdictions) further adds to the opacity of short selling practices. It has been found that short sellers on average are better informed than other market participants, with several studies showing that heavily-shorted stocks perform significantly worse than lightly-shorted stocks, and that this holds across almost all time periods and countries. Apart from being better at analyzing public data, some studies suggest that short sellers on average are better connected in the investor community and therefore have a deeper understanding of market ecology and/or access to insider information.

While performing conspiracy type magic with relation to stocks can be possible, it is extremely difficult to do based solely on the knowledge and ability of the magician. First, there are numerous securities to choose from for use in a magic trick. However, only those securities which are subject to a change in perception are ideal for use in a magic trick. Identifying those securities which are ideal for using in a magic trick is a task which is extremely difficult for a magician to perform (in fact it is a difficult task even for individuals with years of expertise and training in securities investing).

In addition, much of the popularity of a magician depends on the showmanship of the specific magician. Many magicians can perform the same trick but the one who does it with more flare is usually more popular, and thus more financially successful. Additionally, those magicians who can perform unconventional magic tricks will astound today's sophisticated audiences and will be more successful than other magicians. These unconventional magic tricks require unconventional preparation. Therefore, what is needed is a computer assisted magic trick that assists the magician in performing unconventional magic by identifying short selling targets that are best subject to the changes in perceived value needed for the performance of the trick.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a method of performing an unconventional magic trick comprising receiving into a computer system an input of one or more company names, receiving into a computer system an input of one or more personally identifiable public actors, storing one or more data sets in one or more databases in a computer, identifying by a computer a degree of separation between a first publicly traded company and a second publicly traded company which had been previously successfully targeted for a short selling campaign, identifying by a computer one or more publicly traded companies identified in one or more published news articles, searching by a computer one or more published news articles for author bias, identifying by a computer one or more published news articles as being written by independent authors, identifying by a computer one or more published news articles as being written by promoter authors, determining by a computer one or more securities for publicly traded companies most likely to be successfully targeted for a short selling campaign, ranking by a computer a plurality of securities for publicly traded companies in order of most likely to be successfully targeted for a short selling campaign, displaying on a computer screen a plurality of securities for publicly traded companies most likely to be successfully targeted for a short selling campaign, selecting a security for a publicly traded company from a plurality of securities for publicly traded companies in order of most likely to be successfully targeted for a short selling campaign, generating a narrative of one or more publicly traded companies wherein the narrative describes how the accurate value of a security of one or more publicly traded companies is lower than the current perceived value, wherein the narrative comprises one or more published news articles, generating a list consisting of a plurality of correspondents, transmitting by a computer the narrative to one or more correspondents, and performing a magic trick in a live magic show by first deliberately increasing the perceived value of a security of a publicly traded company by an audience and then deliberately decreasing the perceived value of a security of a publicly traded company by presenting the narrative.

In another embodiment the method may further comprise taking a short position in one or more securities of a publicly traded company, generating one or more enhanced tickets to a live performance, wherein the one or more enhanced tickets entitle a bearer to a post-show privilege, distributing at a live magic show one or more certificates of ownership to individuals bearing an enhanced ticket wherein the certificate of ownership evidences the bearer's ownership stake in a short position in a security of a publicly traded company, and realizing a profit in a short position in a security of a publicly traded company and distributing proceeds to individuals bearing certificates of ownership.

The method may further comprise identifying by a computer system one or more databases, issuing by a computer system an automated web request to one or more servers to access the one or more databases, wherein the one or more servers are capable of independently serving automated web requests through retrieving information from the one or more databases, receiving one or more data sets from the one or more databases, wherein the one or more data sets consist of information selected from a group consisting of security trading data for one or more publicly traded companies, public actor information, social network information for one or more board members of one or more publicly traded companies, and published news articles about one or more companies.

The method may further comprise retrieving one or more SEC reports for one or more publicly traded companies, determining if one or more analysts are named in one or more SEC reports, determining if one or more bank analysts are employed by banks named in one or more SEC reports, identifying one or more bank analysts as promoters, identifying one or more bank analysts as independent analysts, determining whether a plurality of price objectives of a predetermined number of promoters are above a plurality of price objectives of a predetermined number of independent analysts, and determining whether an average value of a plurality of price objectives of a predetermined number of promoters is more than fifty percent above a current market value for a security of a publicly traded company.

The method may further comprise receiving by a computer a manipulation factor from a user and varying by a computer a display on a computer screen list of securities for publicly traded companies most likely to be successfully targeted for a short selling campaign based on the manipulation factor.

The method may further comprise receiving by a computer a first set of company board member data comprising board member biographical information and determining by a computer a social link between board members of a first company and board members of a second company.

In another embodiment the method the step of selecting a security from a plurality of securities further comprises selecting a security of a publicly traded company having an overall valuation of less than two billion dollars, a current stock market value, a current stock market value near to a one year high, and a current stock market price greater than a five year average market price.

In another embodiment of the method the step of selecting a security from a plurality of securities further comprises selecting a security of a publicly traded company having a negative cash flow.

The invention is also directed toward a method of performing an unconventional magic trick comprising receiving into a computer system an input of one or more company names, receiving into a computer system an input of one or more personally identifiable public actors, generating by a computer system a plurality of automated web requests to servers storing information and data concerning one or more company names and one or more public actors, receiving by a computer data and information concerning one or more company names and one or more public actors, determining by a computer one or more securities for one or more publicly traded companies most likely to be successfully targeted for a short selling campaign, generating a narrative of one or more publicly traded companies wherein the narrative describes how the accurate value of a security of one or more publicly traded companies is lower than the current perceived value, and performing a magic trick in a live magic show by first deliberately increasing the perceived value of a security of a publicly traded company by an audience and then deliberately decreasing the perceived value of a security of a publicly traded company by presenting the narrative.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of a system utilizing the process of the invention;

FIG. 2 is a schematic of a system utilizing the process of the invention;

FIG. 3 is a schematic of a system utilizing the process of the invention;

FIG. 4 is a schematic of a system utilizing the process of the invention;

FIG. 5 is a schematic of the inventive method;

FIG. 6 is a schematic of the inventive method;

FIG. 7 is a schematic of the inventive method;

FIG. 8 is a schematic of the inventive method;

FIG. 9 is a schematic of the inventive method;

FIG. 10 is a schematic of the inventive method;

FIG. 11 is a schematic of the inventive method;

FIG. 12 is a schematic of the inventive method; and

FIG. 13 is a diagram of a magic show where the method is performed.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

### Overview of Stocks and Method

The invention relies on the fact that the price of any given security on the financial markets is determined by “market conventions”. Market values are based on more or less volatile valuation conventions, which are based on more or less strong and convincing narratives. The invention's approach to short selling focuses on stocks whose valuation convention is particularly weak and uncertain: aiming to realize the short position by disseminating narratives that destroy the current valuation convention and replace it by another, less favorable, valuation convention.

The invention elaborates a systematic and automated method for identifying and exploiting stocks with weak valuation conventions. In particular, the system provides a computer method to assist in setting up a magic trick by finding firms whose profile is vulnerable to the most frequent short-selling narratives (accusations of accounting manipulation, management wrongdoing, management incompetence, stock-promotion, deliberately unrealistic business plans, etc.). It uses a standardized list of tools (such as press releases, class actions law suits, specialized websites and newspapers, etc.) to automatically disseminate its own negative narrative and make targeted stocks fall.

Thus, the invention does not base itself strictly on financial grounds. Contrary to most contemporary algorithms related to short-selling, the inventive method does not try to compare current stock prices with their “fundamental valuation.” Even when it uses financial information, the inventive method does not attempt to ascertain the “fair value” of the stock. Rather it deals with the strength or weakness of the stock's current valuation convention; i.e. how vulnerable the current valuation convention is to negative rhetoric. Based on the fact that theoretical valuation may change according to the theoretical frame (valuation convention) chosen by the majority of the market, the invention's mechanism is based exclusively on perception: it aims to find and to exploit the perception of the factors of valuation convention shifts.

The inventive method incorporated can be seen as two portions. The first portion is the inventive software method which searches and compiles information for the magic trick during a preparation phase. The second portion is the method of targeting a specific company for a short selling campaign, performing the magic trick in front of an audience, shifting the perceived value of the company in front of the audience, and realizing a profit on the short selling of the company security. The inventive software method is used to identify suitable short selling targets. The system starts by obtaining data from a user. The system queries the user to provide three initial sources of data: a list of previously successfully targeted companies, a list of main public actors related to short selling, and any desired modifiers to the method's formula.

The first item requested from the user is a list of previously successfully targeted companies. The invention is based on a network analysis: to perform this analysis, the software requires information on already successfully targeted companies, which it links to potential future short operations. As the user gains short selling experience s/he will be able to add new companies to the database of successful targets. This list is filled with NASDAQ 4-letters codes (e.g. target company Keryx Biopharmaceuticals Inc. is saved as KERX). Any other types of companies or securities may be listed as well. For instance, in another embodiment of the system the method may use companies which have not been previously successfully targeted for short selling campaigns.

The second item requested is a list of main public actors related to short selling. In order to apprehend narrative processes on the financial markets, a database of public actors involved in these narratives is required. The user should identify and add both stock promoters and short-seller journalists. The user adds these people by specifying their media outlet the person works for and the author's specific URL page.

The third item requested is whether the user desires to modify the formula utilized. This input is optional, but it allows the user to modify the formula utilized by the software to rank the results. After the screening phase, the program performs a ranking of all stocks. For this process the system uses a pre-defined formula of the kind: aX+bY+cZ+ . . . +constant. The variables utilized in the formula can be any predetermined factor or factor chosen by the user. The factors could include any relevant factor, such as circulation size, years of experience, number of followers on social media, how many times an article was viewed, or any other measurable characteristic. As the user builds experience s/he can modify the value of each of the pre-defined coefficients in order to refine the results by increasing or decreasing the weight of some factors. The manipulation of the coefficients is known as a “manipulation factor.” Once the user has input the requested information, the information is saved in a database for storage. The information can be saved in one database or may be saved in three separate databases.

After the user inputs the requested information, the software seeks information from websites and databases stored on servers connected to the internet. The software searches these resources for information regarding publicly traded companies on any given exchange and the list of actors provided. The system searches through several sets of data. There are sets of data related specifically to each of the companies provided. There are sets of data related specifically to the financials of the publicly traded security. There are sets of data related specifically to the public actors provided.

The software downloads a set of data on the publicly traded companies in a given exchange and public actors in three phases. First, the software extracts the key financial statistics of each of the stocks listed on a given exchange. The key statistics can include any financial information, such as current price, yearly high, yearly low, yearly average, trading volume, or any other relevant information. The list of relevant information may include, but not be limited to stock price, intraday capitalization, stock price at previous closing, stock price at opening, stock average daily volume, market cap, book value, EBITDA, dividend per share, dividend yield, price-per-share, price-to-earnings ratio, 50-days high, 50-days low, 50-days moving average, 200-days moving average, price-to-earnings growth ratio, operational cash flow, free cash flow, float, insider holding of shares, institutional holding of shares, insider activity, short-ratio, or short percentage of float.

Second, the software seeks stock promotion and short-selling articles. By using the list of public actors, the software downloads and parses the author page for each public actor on the internet. The software identifies all of the articles written by each public actor, the URL of that article, and then downloads each article and saves it to a database. Third, the software downloads the board member information for each company from publicly available databases. The software finds and downloads the name and age of each board member for each company on a given exchange. The software may also seek out any other relevant information about the board members, such as known related individuals, other companies the board member is involved with, years of experience in business, and any other relevant information.

After obtaining the information from public sources on the internet, the software then undertakes a proximity index calculation. The software determines an index of the proximity of each company on a given exchange to previously targeted companies through the analysis of their board members. This index, ranging from 0 (high proximity) to 10 (low proximity), reflects the presence or absence of ties between a company's board members and the board members of previously targeted companies. It is elaborated according to the sociology of social networks.

First, regarding the proximity index calculation, the program attributes an index value of 0 to all board members of successfully targeted companies. Then, it gives a value to the board members of all listed companies through a loop: for n between 1 and 9, the program examines all the board members whose proximity index has not been defined yet. At each iteration of the loop, it attributes a value of n+1 to all board members whose proximity index is undefined and who are involved in a board where at least one board member has a proximity index of n=1. This n proximity index signifies that there are n nodes between the targeted individual (and as a consequence his company) and the board of a previously targeted company. Undefined proximity index after 9 iterations of the loop are set to 10 (these individuals have very low ties with targeted companies). The result of these iterations is that there is a difference of 1 between the value associated at each iteration and the other board members' already existing proximity index (n at first iteration, n+1 at second iteration, n+2 at third iteration, etc.). The board members' database is updated with the proximity index column and saved to the program. Essentially, the proximity index measures the degree of separation between a proposed target company and a successfully targeted company.

For each of the articles downloaded when initializing the software, the program determines the names of companies quoted in each article and whether each article is promotional about the company or short selling the company. First, the program seeks all NASDAQ 4-letter symbols and all full company names in the content of each article. It considers that if a company is quoted at least 3 times in an article, the article is related to this company. Secondly, the software determines whether the article is promotional or short selling. The program first checks the content of article disclaimers; it parses all articles with disclaimers and determines whether the article's author is short (short seller) or long (promoter) on the stock. In case there is no disclaimer, the program seeks for particular keywords which may indicate the position of the article. Keywords which would indicate that the article endorses short-selling the stock may include, but not be limited to, bullish, bulls, promoters, promotion, hype, deceiving, silly, idiot, stupid, underperform, overvalued, slow, low, flop, failure, cash, cash burning, investigate, bubble, bust, insider, stock-options, or SEC filings. Keywords which would indicate that the article promotes the stock may include, but not be limited to, bearish, bears, undervalued, revenue, profit, ambitious, short-sellers, attack, announcement, important announcement, announce, value, value investor, innovative, successful, dramatically, success, excited, exciting, or amazing. If at least 5 promotional keywords are found in an article, the article is labeled as promotional. If at least 5 short selling keywords are found in an article, the article is labeled as short-selling. If the program does not find 5 of the listed keywords, or if it finds both promotional and short-selling keywords, the article is considered neutral. The software then adds up the total number of each type of article for each company and saves it in the database.

The software extracts from specialized websites (such as gurufocus.com) insider activity and manipulation scores (M-Score, O-Score) for each of the stocks. It then adds these to the stock database. The O-Score is the Ohlson O-score which is a multi-factor financial formula used for predicting bankruptcy. The calculation for Ohlson's O-Score is as follows:

$$T = - 1.32 - 0.407 ln ( {TA}_{t} ) + 6.03 \frac{{TL}_{t}}{{TA}_{t}} - 1.43 \frac{{WC}_{t}}{{TA}_{t}} + 0.0757 \frac{{CL}_{t}}{{CA}_{t}} - 1.72 X - 2.37 \frac{{NI}_{t}}{{TA}_{t}} - 1.83 \frac{{FFO}_{t}}{{TL}_{t}} + 0.286 Y - 0.521 \frac{{NI}_{t} - {NI}_{t - 1}}{\vert {NI}_{t} \vert + \vert {NI}_{t - 1} \vert}$$

where TA=total assets; TL=total liabilities; WC=working capital; CL=current liabilities; CA=current assets; X=1 if TL>TA, 0 otherwise; NI=net income; FFO=funds from operations; and Y=1 if a net loss for the last two years, 0 otherwise. The M-Score is a mathematical model that uses eight financial ratios to identify whether a company has managed or manipulated its earnings. The variables are constructed from the company's financial statements and create a score to describe the degree to which the earnings have been manipulated. The M score is based on a combination of the following eight different indices:
DSRI=Days' Sales in Receivables Index. This measures the ratio of days' sales in receivables versus prior year as an indicator of revenue inflation.
GMI=Gross Margin Index. This is measured as the ratio of gross margin versus prior year. A firm with poorer prospects is more likely to manipulate earnings.
AQI=Asset Quality Index. Asset quality is measured as the ratio of non-current assets other than plant, property and equipment to total assets, versus prior year.
SGI=Sales Growth Index. This measures the ratio of sales versus prior year. While sales growth is not itself a measure of manipulation, the evidence suggests that growth companies are likely to find themselves under pressure to manipulate in order to keep up appearances.
DEPI=Depreciation Index. This is measured as the ratio of the rate of depreciation versus prior year. A slower rate of depreciation may mean that the firm is revising useful asset life assumptions upwards, or adopting a new method that is income friendly.
SGAI=Sales, General and Administrative expenses Index. This measures the ratio of SGA expenses to the prior year. This is used on the assumpton that analysts would interpret a disproportionate increase in sales as a negative signal about firms future prospects
LVGI=Leverage Index. This measures the ratio of total debt to total assets versus prior year. It is intended to capture debt covenants incentives for earnings manipulation.
TATA—Total Accruals to Total Assets. This assesses the extent to which managers make discretionary accounting choices to alter earnings. Total accruals are calculated as the change in working capital accounts other than cash less depreciation.
   The eight variables are then weighted together according to the following formula:

M=−4.84+0.92*DSRI+0.528*GMI+0.404*AQI+0.892*SGI+0.115*DEPI−0.172*SGAI+4.679*TATA−0.327*LVGI.

The software then calculates a ranking formula based on the acquired information and historical data. The coefficients are calculated through logistic regressions aiming to determine theoretical coefficients that maximize ranking accuracy for future short-selling operations.

The software then parses all companies' underwriting agreements submitted to the SEC and available online, and all broker notes regarding each company published by investment bank analysts. The program separates analysts into two separate groups: the group of analysts whose bank is named in SEC files (promoters) and the group of analysts whose bank is not named in SEC files (independent). If 80% or more of the broker notes published on the company are by promoters, then the correlation index is set to 1. If promoters' price objectives are more than 20% above independent's price objectives or if promoters' price objectives are more than 50% above the current stock price, the correlation index is set to 1. If none of these requirements are met, correlation index is set to 0. In this manner the correlation index is an indicator of the existence of a conflict of interest by the company's analysts.

In addition, the software calculates the correlation ratio between the fact of being categorized as a promoter and price objective: if the correlation ratio is positive and its p-value is lower than 0.05 it calculates it. The software calculates the statistical p-value of the chi-square test. The p-value can fluctuate between 0 and 1. As an example, if all of the investment banks paid by the company target a price of $20 per share and all independent brokers target a price of $10 per share, then the correlation ratio will be 1. The p-value can fluctuate depending on the distribution of target prices of the promoters and the independent bankers. Thus, the p-value enables the system to eliminate cases where a correlation appears positive but cannot be proven in reality. The correlation index and correlation ratio are added to the stock information database and saved.

When launched, the software checks that all the databases exist. If they do not exist, the software creates them. If the databases do exist, and if they are older than one month, the software updates the information (i.e. promoters/short-sellers' articles, stock data, board members' information) and recompiles the proximity index.

After updating the information, the software then seeks stocks whose valuation convention is vulnerable to narratives. In order to do so, it elaborates a short-list of stocks that abide by a cumulative list of criteria. Any number and type of criteria may be used. The criteria may be set at a predetermined level, may fluctuate between a set range, or be determined relative to each company. In the preferred embodiment the software utilized the following set of criteria: low overall valuation (<$2 bn); current stock price near to its one year high (current price>=0.9*OneYearHigh); current stock price significantly superior to its five year average (current price>=1.5*FiveYearAverage); moderate to high short-interest (between 10% and 25%); favorable sector (highly technical or risky sectors such as: Chinese companies; mining or extraction companies; biotechs; fintechs; other sectors to be added depending on market bubbles); negative operating cash flows; recent company (younger than 10 years); proximity index ranging between 0 and 3 (included); company quoted at least twice by promoters and/or short-seller journalists.

The software method offers a distinction between the calculation of the formula and the execution of the formula. Calculation and execution are both based on the same data and information as indicated above. The process of calculation compares the data with data from one or more previously successfully targeted companies. The process of execution, on the other hand, extrapolates the formula's results from data for a single company.

After determining which companies are vulnerable to narratives, the software calculates a rank score for each company utilizing a predefined formula. In other embodiments the formula may be predefined by the user. The software then displays the five companies with the highest rank score. The software may be altered to change the number of companies displayed to any number, such as more than five or less than five.

After determining the top five companies which are vulnerable to narratives which would cause the stock value to lower, the software then displays, for each stock, the list of promotional and/or short-selling articles related to the stock, promotional broker notes, board member relations to previously targeted companies, and the most worrying financial data regarding the target company.

Next, the user selects the company for targeting. The user may input the selected company into the software. Alternatively, the software itself may select a specific company for targeting.

The user then attempts to frame the target company. Finding a company that is overvalued, fraudulent, corrupt or mismanaged is not enough. The final selection criteria is determining if there is a newsworthy story to be told which would cause the value of each company's stock to lower. The ranked list of companies suggested by the software, together with the program's identification of the key narratives surrounding the company, is used as a basis for closer investigation. The user may undertake further research into evidence about how each company has been promoted, such as whether each has been strongly supported by famous analysts or investment banks, or whether payments can be traced from each company to the respective analysts and investment banks. Alternatively, the software may automatically perform a scraping function on the internet to search for additional evidence or links of evidence.

The user utilizes the software to create a story about the selected company. The story consists of two main elements—that the target company is essentially worthless and the process by which the company became overvalued. First the user attempts to illustrate that the target company is essentially worthless in that it is little more than a vehicle for handing out money to corrupted board members. In order to build this part of the story, the user may need to consult experts within the sector the target company operates in (in order to assess the claims the target company is making about its product or service) and/or experts from the country of operation (in order to find out on-the-ground what the target company is up to). If the user senses that there is more serious corruption going on, then the user may utilize private investigators and forensic accountants. Second, the user needs to show how the target company became overvalued or how it fooled the market using stock promoters. It is always this second point which is more convincing, since one can never know for certain the correct valuation of a company. It is therefore advisable for the user to focus on this second point and find out about the company's stock promotion scheme. Alternatively, the software may create the story for the user by uploading a template story or utilizing a prior story and updating it based on current information. This story is utilized to effect a change in perceived value of the company.

Smaller companies are by default less newsworthy, and therefore require a “better story” in order to gain attention in mainstream media. However, this problem is partially overcome with more specialized online investment forums. With large companies and well-known brands, almost any story is newsworthy, but on the other hand it is much more difficult to affect the valuation of a large company. The user carefully considers the story to tell, according to the guidelines given above, and ensures that all information is truthful to the best of the user's knowledge.

The final step in preparations is for the user to identify key people who can effectively circulate the findings about the target company without the user being visible as the source. In the realm of magic, these individuals are often called “stooges.” Depending on the type of company chosen, and the story the user has to offer, different distribution channels may be more or less suitable. If the story has a high degree of general interest, the user may approach journalists at mainstream financial media. In most cases, however, it is more practicable to find writers on finance forums who frequently take ‘bearish’ positions and have substantial followings. Whomever the user chooses to contact with the research, the user should make sure to keep all communication anonymous, so the origin of the story cannot be traced back to the user. In another embodiment, software includes a list of short-selling journalists. In this embodiment the software presents the user with a list of potential stooges. The user can then select the potential stooges from the list and the software automatically distributes the story to the stooges to maintain the anonymity of the user.

The user gives a writer/journalist an angle for a story and all the necessary facts. This is something valuable to most writers who have little time to do their own research. The user tells the writer to check the facts themselves and that the user does not want to be mentioned as a source. If the user does his/her research well and offers good stories, the writers or “stooges” will grow increasingly confident with the user's work over time. In other embodiments the software of the system automatically performs these steps.

Depending on the case the user has against the target company, the user may also want to involve a legal firm to make a class action lawsuit on behalf of the company's shareholders, also known as a derivative lawsuit. Such lawsuits will become instantly visible on the newsfeed of anyone following the company on online newsfeeds, and therefore makes for another powerful tool of communication.

Because the system and method are very similar to the methods utilized by magicians, the method can be further utilized in the context of a magic show on a stage in front of an audience.

There are several variations of how this trick can be played in the context of a stage show. The trick being performed in front of an audience will be described in its preferred embodiment although other variations may be utilized. In the standard embodiment, the magic show has two ticket options: one is simply a ticket to a magic show. The other is a ticket to participate in the “conspiracy magic” of the show. That is, for an additional specified amount of money to buy into the magic trick—a magic trick played out on the financial markets. Those who do not buy into the trick prior to the show can be given additional opportunities during the show.

During pre-show preparations the magician utilizes the software method for choosing a target company. The magician researches and prepares the story to tell about this company. The magician then places a certain amount of money in a short sale of the target company's stock. This is also the short position the magician lets audience members buy into. The positioning of the short sale should take place prior to the premiere of the magic show.

Coinciding with the opening night of the show, the magician begins anonymously distributing the information gathered about the target company to a selected network of writers and stooges. The content of the stage show is flexible, but its purpose is to provide context for the short selling magic trick. It can include a variety of other tricks that reference the short selling magic trick, such as mind reading routines, news predictions, or other “money tricks”. Reference can also be made through a dramaturgical structure of exposing—or pretending to expose—tricks within the show, or through storytelling and patter providing context to conspiracy magic and short selling methods. The show can also be used to persuade those who have not already bought into the short selling magic trick, through their choice of ticket, to do so.

Upon leaving the magic show, those audience members who have bought into the short selling magic trick each receive a certificate of investment with a promise to realize their financial magic within a given timeframe (usually within 6 months or 1 year). Their contact and bank details are collected by the magician at the time of the show. The audience members also receive a brochure detailing the case against the target company and full disclosure about the short sale, including the price at which the short position was taken on their behalf and a target price for realizing the short. This brochure can be seen in the tradition of the magician's souvenir book, which gives out tricks to bring home at the end of a show. In the case of the short selling magic trick, the fact that the method is revealed to the audience during the show does not diminish the magic effect. On the contrary, making the audience complicit in a short selling campaign—which they usually only partially understand—is a prerequisite for achieving the magic effect.

The trick is complete once the short sale has been successfully realized, and the audience members have received their share of the profit. There are several magic effects at play here, with possible variations depending on how the trick is introduced or performed. Among the effects generally considered magical effects, the three most applicable to the short selling magic trick are transformation (changing the appearance of the target company and thus its value in the marketplace), thought transmission (projecting our belief about the value of the target company onto others), and prediction (foreseeing the future loss in value of the target company).These magic effects are enhanced by the fact that stock prices are public and easily accessible, making the target company's predicted loss in value verifiable to anyone. When successful, the short selling magic trick offers the bedazzling experience of magic actually impacting the “real” world.

### Detailed Description of the Inventive Method

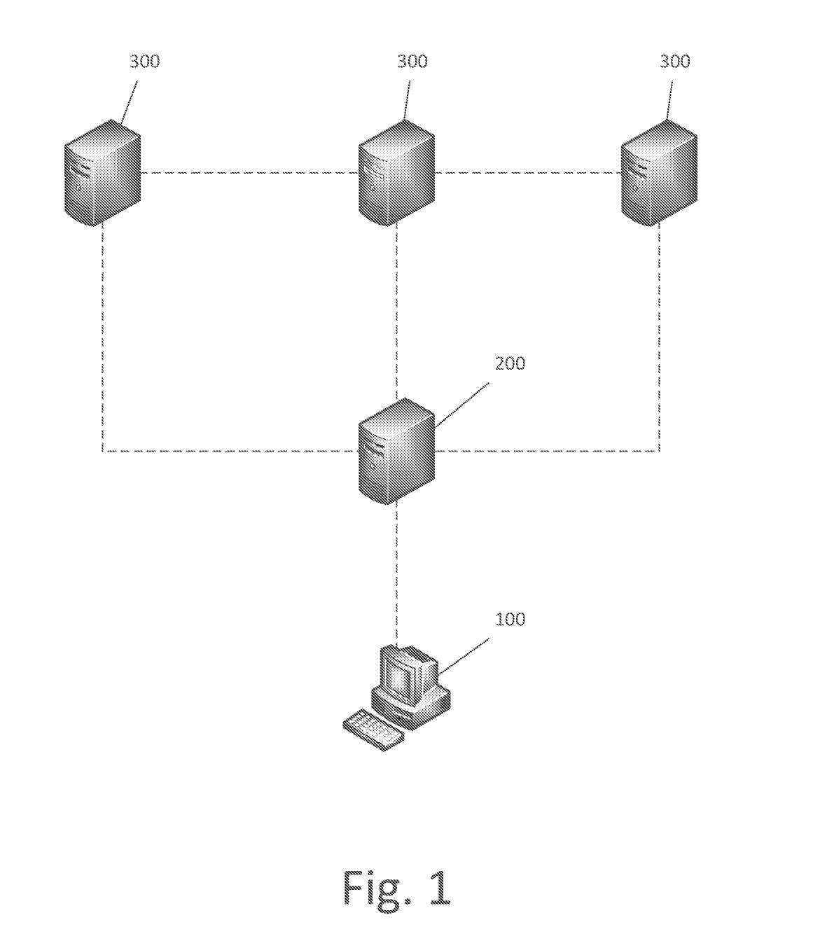

Referring to FIG. 1, the system performing the inventive method is displayed. The system comprises one or more client side computers 100. The client side computer 100 is the computer interface utilized by the user to access and run the software system. The client side computer 100 may be any type of communicative computerized interface device, including but not limited to a desktop computer, tablet computer, laptop computer, smart phone, or any other computerized communicative device. The client side computer 100 is communicatively coupled to a server computer 200. In the preferred embodiment the inventive software method is stored and executed on the server computer 200. In other embodiments the inventive software method is stored and executed on the client side computer 100. The server computer 200 may be a single stand-alone server computer or a stack of multiple server computers communicatively coupled together. The server computer 200 is communicatively coupled to one or more resource servers 300. There may be any number of resource servers 300.

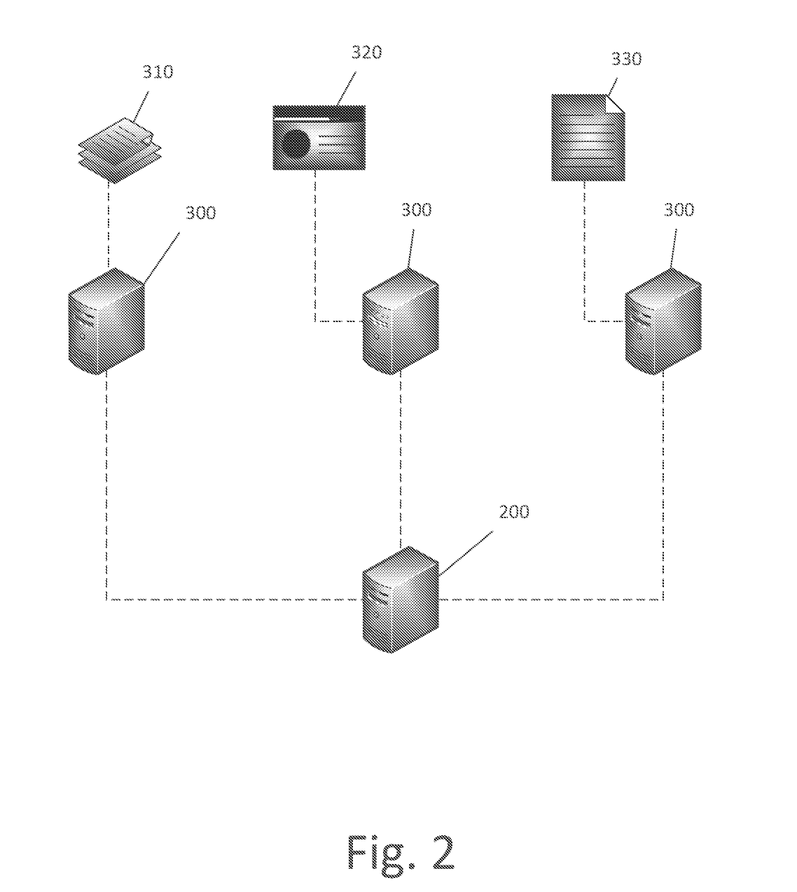

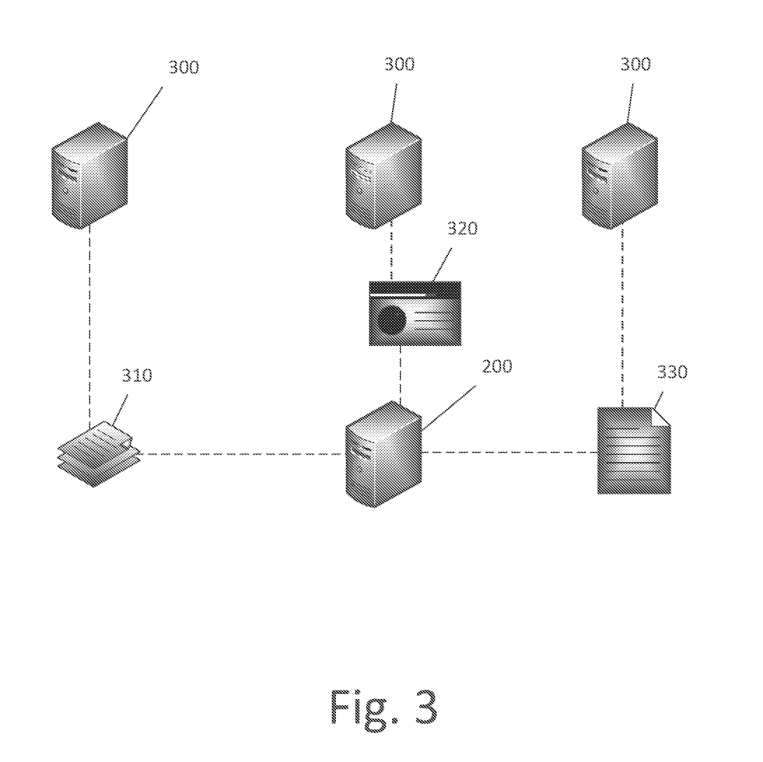

The resource servers 300 are third party computers and servers which store information, files, and data from which the server computer 200 can scrape and access data. As shown in FIG. 2 the resource servers can store company stock information 310, public actor profiles 320, and published articles 330. The server computer 200 searches the resource servers 300 for information related to information input by a user. As shown in FIG. 3, once the server computer 200 finds pertinent information stored on a resource server 300, the server computer 200 requests a copy of the information to be transferred to the server computer 200. The server computer 200 can then accept and store copies of relevant company stock information 310, public actor profiles 320, published articles 330, or any other relevant data and information related to information input by a user.

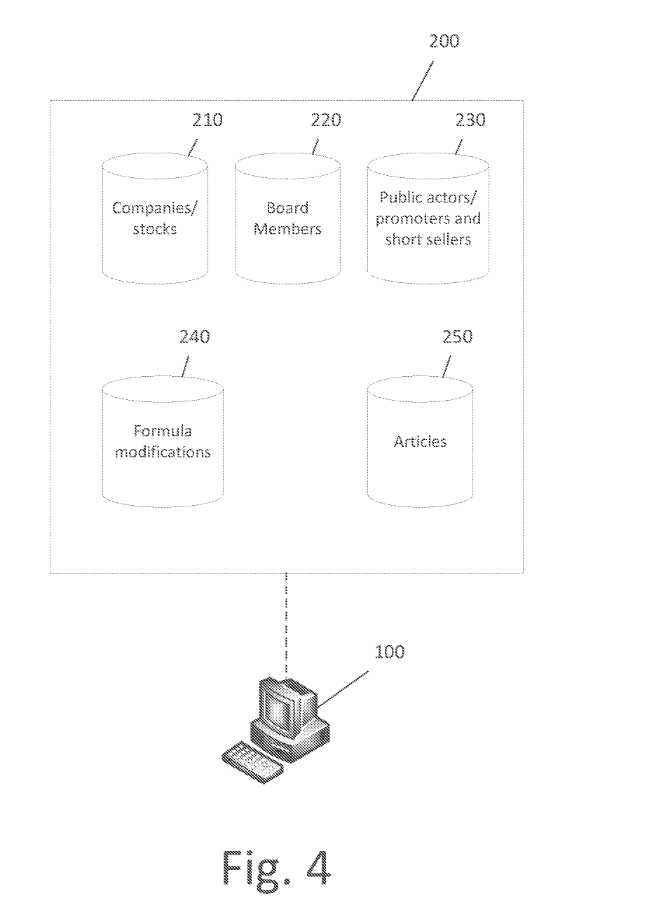

As shown by FIG. 4, once the server computer 200 receives the information, the server computer 200 stores the information in one or more databases. The databases can be preexisting prior to the server computer acquiring the information or can be created by the server computer after receiving the information. In the preferred embodiment, the server computer 200 creates and stores information in a company/stock database 210, a board members database 220, a public actors database 230, a formula modifications database 240, and an articles database 250. The company/stock database 210 receives and stores information related to the financial information for any company or stock. This can include yearly stock average, yearly high, yearly low, average trading volume, company capitalization, amount of public stock, amount of outstanding stock, financial performance of the company, corporate structure, corporate expenses, corporate revenue, current company valuation, past company valuation, valuation projections, company cash flow, or any other company specific information or stock specific information. The board members database 220 receives and stores information about the board members for each company input by a user. The information may include but not be limited to current board members of a company, past board members of a company, work experience for each board member, known social contacts for each board member, known income or personal wealth for each board members, known companies for which a board member has served as a board member, known personal activities for each board member, known political affiliations for each board member, known public causes and charities supported by each board member, and any other relevant board member information. The public actors database 230 receives and stores information related to known promoters of a company, known short sellers of a company, known brokers of a company or stock, known financial advisers of a company, investment banks known to be affiliated to a company, or any other relevant information pertaining to public actors who have an influence on a stock value or attempt to have an influence on a stock value. The formula modifications database 240 receives and stores user preferences related to the ranking formula computed by the system. The articles database 250 receives and stores information related to public articles about a company, including but limited to financial performance articles, stock valuation articles, public relations articles, social media posts, or any other type of article related to a company input into the system by a user.

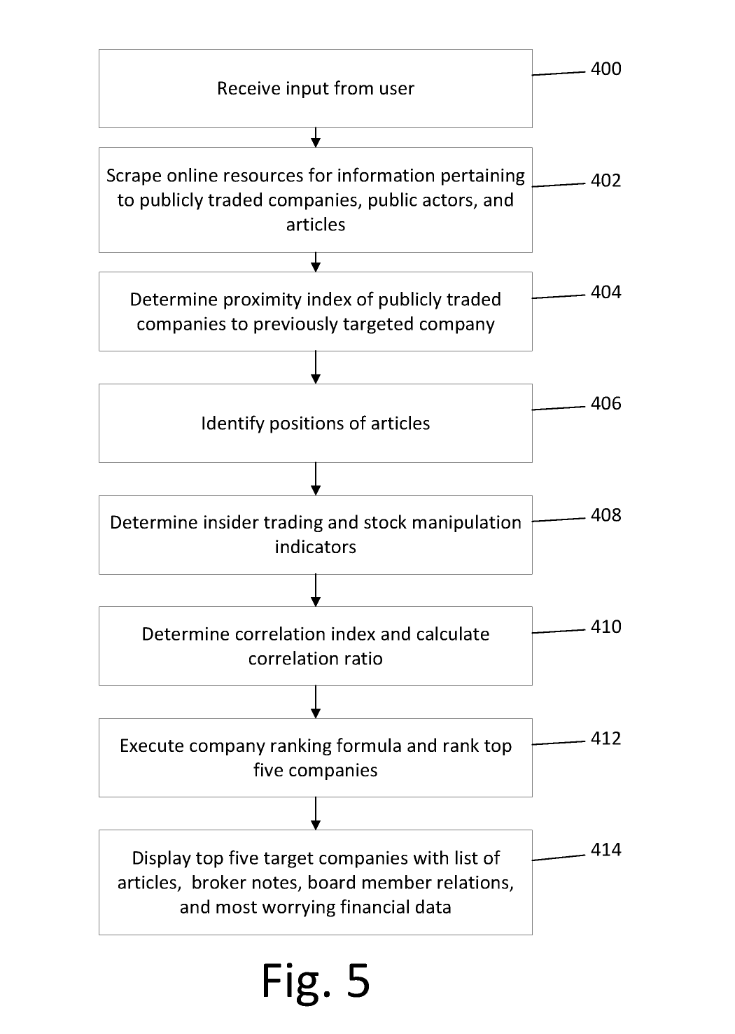

Referring to FIG. 5 through FIG. 12, the method of the invention is displayed. The method may be performed in any order, not necessarily in the order shown and described. No step described in the method is mandatory and the inventive method can be performed without the utilization of any single step. Furthermore, any step can be performed in any number of embodiments and equivalents without departing from the scope of the invention.

Referring to FIG. 5, the overall computerized method is displayed. The method starts when the system receives input information from a user 400. The system then scrapes online resource servers for online resources and information pertaining to publicly traded companies, public actors, published articles, and any other relevant information 402. The system then determines the proximity index of publicly traded companies to previously targeted companies 404. The system then identifies the positions of articles received 406. The system then determines if evidence indicative of insider trading or stock manipulation exists 408. The system then determines the correlation index and calculates the correlation ratio for articles related to an input company 410. The system then executes the company ranking formula and ranks the top five companies which are in a position to build a short selling campaign against 412. The system then displays the top five target companies to the user with a list of articles, broker notes, board member relations, most worrying financial data about the company, and any other information or evidence which may be used to build a short selling campaign against a target company 414. The system may be modified to display less than five companies or more than five companies.

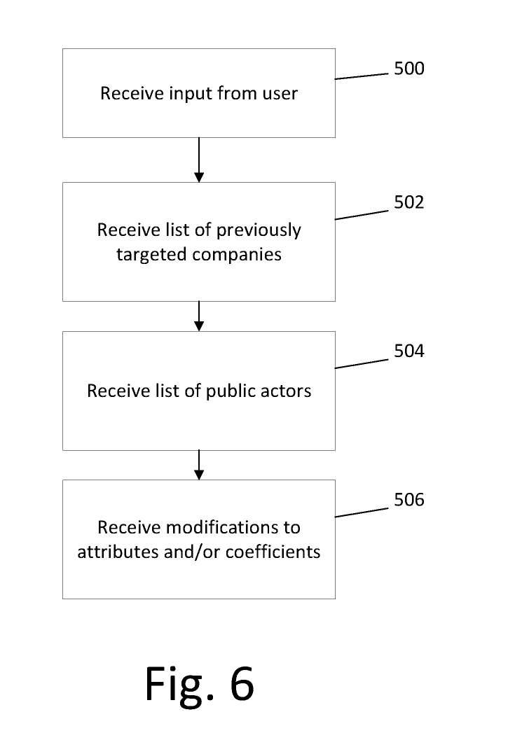

Referring to FIG. 6, the method of system receiving information from the user is illustrated. The system receives information from input from the user 500. Within this process, the system receives a list of previously targeted companies from the user 502. The system also receives a list of public actors from the user 504. The system can receive modifications to attributes and coefficients of the ranking formula executed by the system 506. The user may select any attribute of the company, public actor, or articles utilized in the ranking formula to be promoted over other attributes. For instance, and by no means limiting the system, the user can select to promote the attribute of the current value of a stock of a company as favored against the number of articles promoting a company. In other embodiments of the invention the method can be performed without user input, where the system automatically seeks information related to public companies, public actors, and articles and automatically presents to a user the best companies which may be targeted.

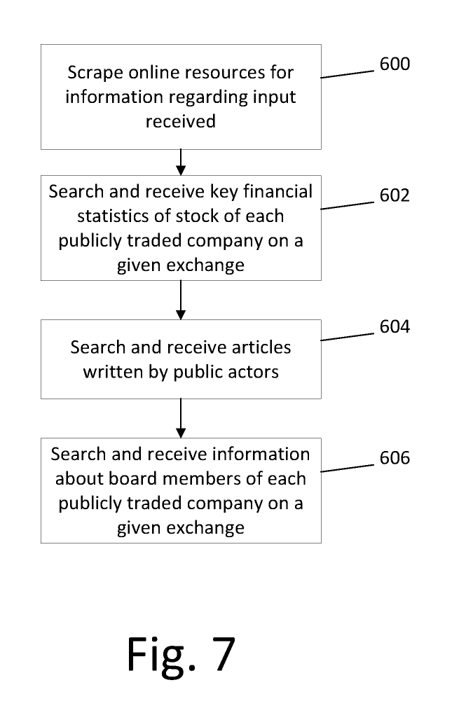

Referring to FIG. 7, the method of the system scraping resource servers for information is displayed. The system first scrapes online resource servers for information related to the input received from a user 600. The system searches and receives key financial statistics of the stock for each publicly traded company on a given exchange 602. The system searches and receives articles written or published by public actors 604. The system searches and receives information about board members of each publicly traded company on a given exchange 606.

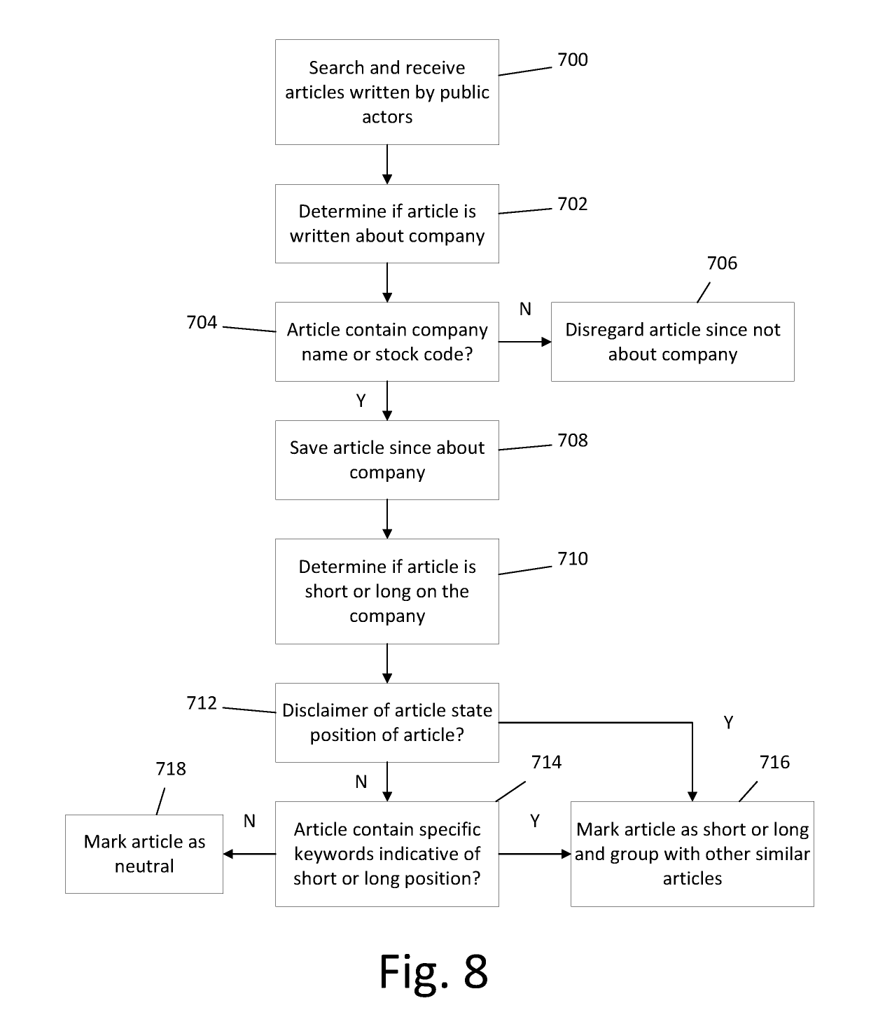

Referring to FIG. 8, the method of the system searching and receiving articles is displayed. First, the system searches and receives articles written by public actors 700. In other embodiments the system looks for any articles or published information about a company, regardless of who wrote the article. Then the system determines if the article is written about the target company 702. The system determines whether the article contains the company name or company stock code 704. If it does not then the system disregards the article since it is not about the company 706. If it does contain the company name or company stock code then the system saves the article since it is about the company 708. The system then determines whether the stock promotes the company (is taking a long position) or is degrading the company (is taking a short position) 710. First the system checks for clear statements of a position in the disclaimer section of the article 712. If the disclaimer of the article states its position then the system marks the article as long or short and groups the article with similar articles 716. If the article does not contain a disclaimer or the disclaimer does not state a position then the system determines whether the article contains specific keywords indicative of a long or short position 714. If the article does not contain specific keywords indicative of a position, the system marks the article as neutral 718. If the article does contain specific keywords indicative of a long or short position, the system then marks the article as long or short and groups the article with other similar articles 716.

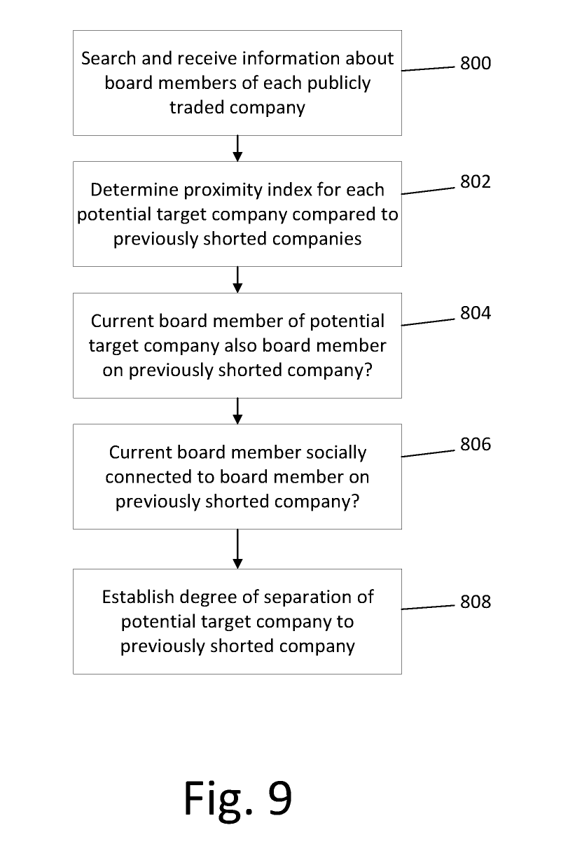

Referring to FIG. 9, the method of obtaining information about board members is displayed. The system first searches for and receives information about the board members of each publicly traded company on a given exchange which is a potential target company 800. The system determines the proximity index for each potential target company compared to previously shorted companies 802. The system determines whether the current board members of a potential target company are also board members on a previously shorted company 804. The system determines whether current board members of a potential target company are socially connected to board members of a previously shorted company 806. The system then establishes a degree of separation between the current potential target company and a previously shorted company 808.

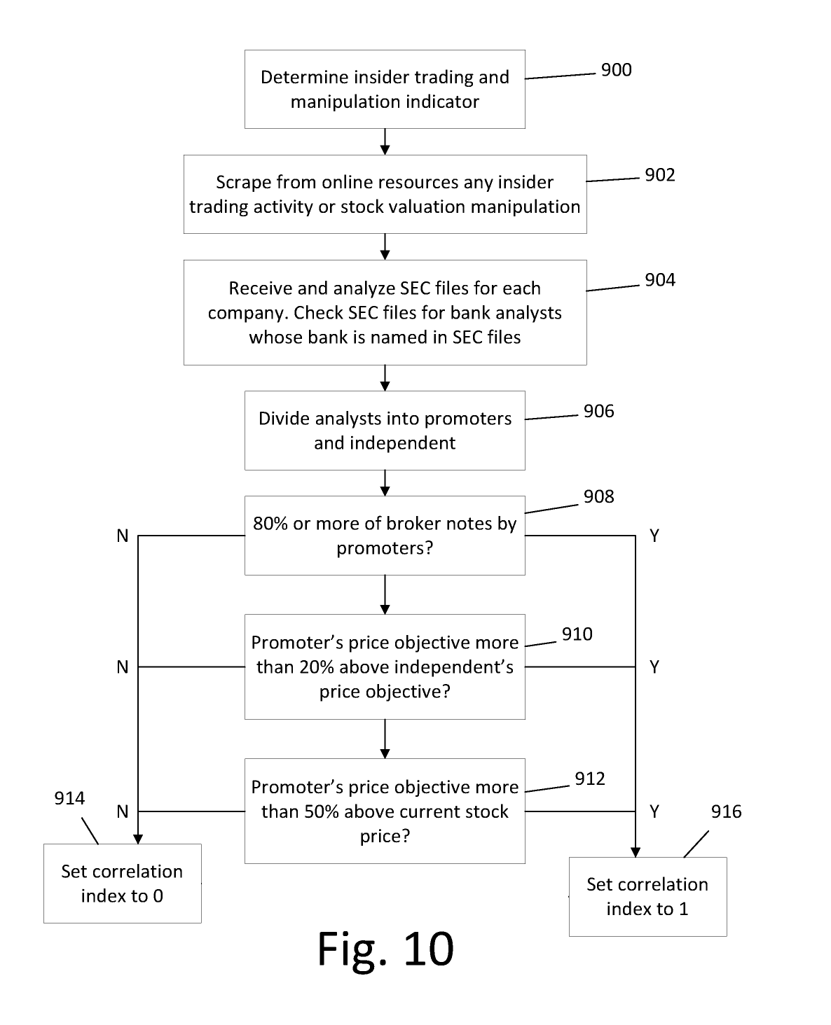

Referring to FIG. 10, the method of determining stock manipulation is displayed. The system determines whether there is evidence of insider trading or stock manipulation 900. The system scrapes evidence of insider trading and stock manipulation from online resources 902. The system then receives and analyzes SEC files for each target company and SEC files for bank analysts whose bank is named in the target company SEC files 904. The system divides the analysts into stock promoters or independent 906. The system determines if 80% or more of the broker notes are by promoters 908. The system separately determines if the promoters' price objective is more than 20% above the independents' price objective 910. The system separately determines whether the promoters' price objective more than 50% above the current stock price 912. If the system determines that any of these conditions exist then the system sets the correlation index to one 916. If the system determines that none of these conditions exist then the system sets the correlation index to zero 914.

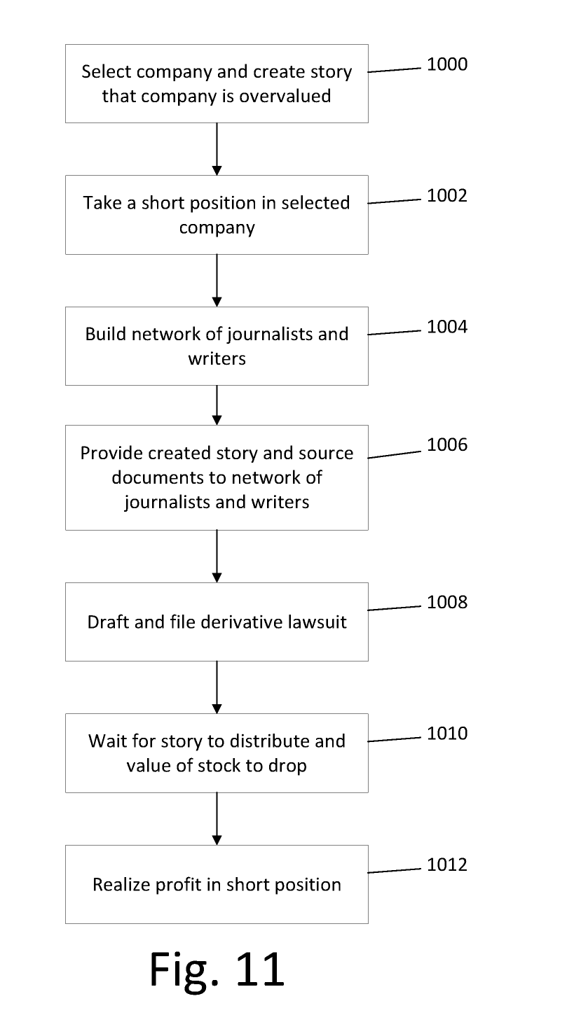

Referring to FIG. 11 the method of utilizing the results of the computerized method is displayed. First the user selects a target company and uses the computer output to create a story that the target company is overvalued 1000. The user then takes a short position in the selected target company 1002. The user builds a network of journalists and writers 1004. The user provides the created story and source evidence documents to the network of journalists and writers 1006. Optionally, the user may draft and file a derivative lawsuit against the selected target company 1008. The user then waits for the story to distribute among the public and the value of the stock to drop 1010. The user then realizes a profit in the short position 1012.

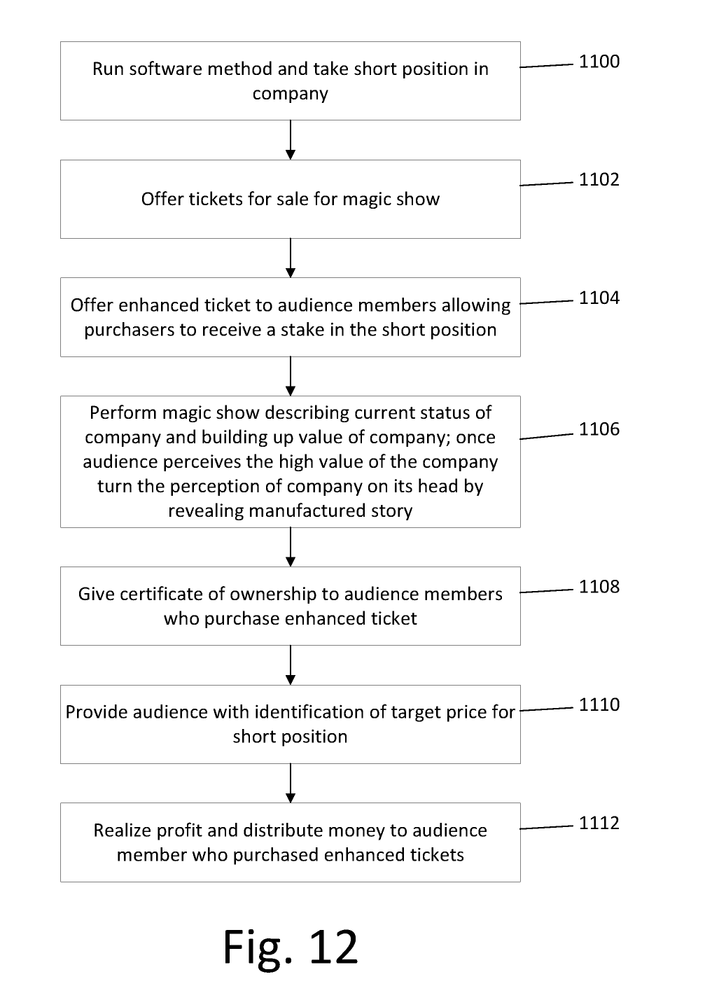

Referring to FIG. 12, the method of incorporating the computerized method into a magic show is illustrated. First the user runs the software and takes a short position in the company 1100. The user then offers tickets to the magic show for sale 1102. The user then offers enhanced tickets to audience members which allow the purchasers to receive a stake in the short position 1104. The user performs the magic show, describing the current status of the company and building up the perceived value of the company; once the audience perceives the high value of the company the user turns the perception of the company on its head by revealing the manufactured story 1106. The user gives a certificate of ownership to the audience members who purchased the enhanced ticket 1108. The user provides the audience with an identification of target price for the short position 1110. The user then realizes a profit in the short position and distributes money to audience members who purchased enhanced tickets 1112.

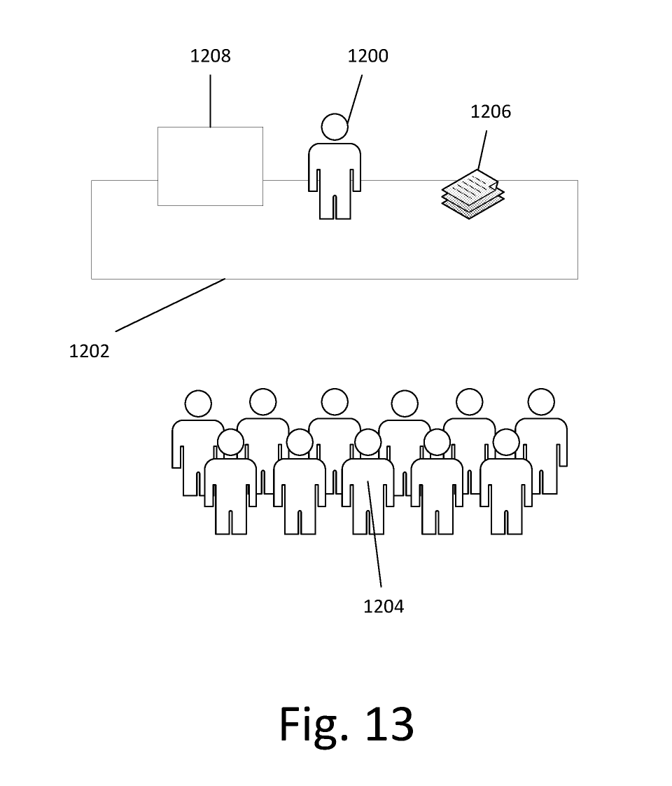

Referring to FIG. 13, a schematic of the magic show is illustrated. The magician 1200 stands on a stage 1202 or other area which is set apart. The magician 1200 performs the magic show for an audience 1204. The magician utilizes a plurality of certificates of ownership 1206 which the magician 1200 distributes to members of the audience 1204 who have purchased enhanced tickets. Optionally, the magician 1200 may use a display 1208 to assist in the presentation of the magic show to the audience 1204. The display 1208 may be a screen on which images may be projected, a multimedia presentation device, a television, a movie screen, a whiteboard, a paper presentation pad, or any other device for writing or displaying information.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A method of performing an unconventional magic trick comprising
a) receiving into a computer system an input of one or more company names of a first publicly traded company which had been previously successfully targeted for a short selling campaign;
b) receiving into a computer system an input of one or more personally identifiable public actors;
c) storing one or more data sets in one or more databases in a computer;
d) identifying by a computer a degree of separation between at least one of said one or more first publicly traded companies and a second publicly traded company;
e) identifying by a computer one or more published news articles identifying said second publicly traded company;
f) searching by a computer one or more published news articles for author bias;
g) identifying by a computer one or more published news articles as being written by independent authors;
h) identifying by a computer one or more published news articles as being written by promoter authors;
i) determining by a computer one or more securities for publicly traded companies most likely to be successfully targeted for a short selling campaign;
j) ranking by a computer a plurality of securities for publicly traded companies in order of most likely to be successfully targeted for a short selling campaign;
k) displaying on a computer screen a plurality of securities for publicly traded companies most likely to be successfully targeted for a short selling campaign;
l) selecting a security for a publicly traded company from a plurality of securities for publicly traded companies in order of most likely to be successfully targeted for a short selling campaign;
m) generating a narrative of one or more publicly traded companies wherein said narrative describes how the accurate value of a security of one or more publicly traded companies is lower than the current perceived value, wherein said narrative comprises one or more published news articles;
n) generating a list consisting of a plurality of correspondents;
o) transmitting by a computer said narrative to one or more correspondents;
p) performing a magic trick in a live magic show by first deliberately increasing the perceived value of a security of a publicly traded company by an audience and then deliberately decreasing the perceived value of a security of a publicly traded company by presenting said narrative.

2) The method as in claim 1 further comprising
a) taking a short position in one or more securities of a publicly traded company;
b) generating one or more enhanced tickets to a live performance, wherein said one or more enhanced tickets entitle a bearer to a post-show privilege;
c) distributing at a live magic show one or more certificates of ownership to individuals bearing an enhanced ticket wherein said certificate of ownership evidences the bearer's ownership stake in a short position in a security of a publicly traded company;
d) realizing a profit in a short position in a security of a publicly traded company and distributing proceeds to individuals bearing certificates of ownership.

3) The method as in claim 1 further comprising
i) identifying by a computer system one or more databases;
ii) issuing by a computer system an automated web request to one or more servers to access said one or more databases, wherein said one or more servers are capable of independently serving automated web requests through retrieving information from said one or more databases;
iii) receiving one or more data sets from said one or more databases, wherein said one or more data sets consist of information selected from a group consisting of
(1) security trading data for one or more publicly traded companies;
(2) public actor information;
(3) social network information for one or more board members of one or more publicly traded companies;
(4) published news articles about one or more companies.

4) The method as in claim 3 further comprising
a) retrieving one or more SEC reports for one or more publicly traded companies;
b) determining if one or more analysts are named in one or more SEC reports;
c) determining if one or more bank analysts are employed by banks named in one or more SEC reports;
d) identifying one or more bank analysts as promoters;
e) identifying one or more bank analysts as independent analysts;
f) determining whether a plurality of price objectives of a predetermined number of promoters are above a plurality of price objectives of a predetermined number of independent analysts;
g) determining whether an average value of a plurality of price objectives of a predetermined number of promoters is more than fifty percent above a current market value for a security of a publicly traded company.

5) The method as in claim 4 further comprising
a) receiving by a computer a first set of company board member data comprising board member biographical information;
b) determining by a computer a social link between board members of a first company and board members of a second company.

6) The method as in claim 5 wherein selecting a security from a plurality of securities further comprises selecting a security of a publicly traded company having an overall valuation of less than two billion dollars, a current stock market value near to a one year high, a current stock market price greater than a five year average market price.

7) The method as in claim 6 wherein selecting a security from a plurality of securities further comprises selecting a security of a publicly traded company having a negative cash flow.

8) The method as in claim 7 further comprising
a) receiving by a computer a manipulation factor from a user;
b) varying by a computer a display on a computer screen of a list of securities for publicly traded companies most likely to be successfully targeted for a short selling campaign based on said manipulation factor

9) The method as in claim 8 further comprising
a) taking a short position in one or more securities of a publicly traded company;
b) generating one or more enhanced tickets to a live performance, wherein said one or more enhanced tickets entitle a bearer to a post-show privilege;
c) distributing at a live magic show one or more certificates of ownership to individuals bearing an enhanced ticket wherein said certificate of ownership evidences the bearer's ownership stake in a short position in a security of a publicly traded company;
d) realizing a profit in a short position in a security of a publicly traded company and distributing proceeds to individuals bearing certificates of ownership.

10) The method as in claim 1 further comprising
a) retrieving one or more SEC reports for one or more publicly traded companies;
b) determining if one or more analysts are named in one or more SEC reports;
c) determining if one or more bank analysts are employed by banks named in one or more SEC reports;
d) identifying one or more bank analysts as promoters;
e) identifying one or more bank analysts as independent analysts;
f) determining whether a plurality of price objectives of a predetermined number of promoters are above a plurality of price objectives of a predetermined number of independent analysts;
g) determining whether an average value of a plurality of price objectives of a predetermined number of promoters is more than fifty percent above a current market value for a security of a publicly traded company.

11) The method as in claim 1 further comprising
a) receiving by a computer a manipulation factor from a user;
b) varying by a computer a display on a computer screen of a list of securities for publicly traded companies most likely to be successfully targeted for a short selling campaign based on said manipulation factor.

12) The method as in claim 1 further comprising
a) receiving by a computer a first set of company board member data comprising board member biographical information;
b) determining by a computer a social link between board members of a first company and board members of a second company.

13) A method of performing an unconventional magic trick comprising
a) receiving into a computer system an input of one or more company names of a first publicly traded company which had been previously successfully targeted for a short selling campaign
b) receiving into a computer system an input of one or more personally identifiable public actors;
c) generating by a computer system a plurality of automated web requests to servers storing information and data concerning one or more company names and one or more public actors;
d) receiving by a computer data and information concerning one or more company names and one or more public actors;
e) determining by a computer one or more securities for one or more publicly traded companies most likely to be successfully targeted for a short selling campaign;
f) generating a narrative of one or more publicly traded companies wherein said narrative describes how the accurate value of a security of one or more publicly traded companies is lower than the current perceived value;
g) performing a magic trick in a live magic show by first deliberately increasing the perceived value of a security of a publicly traded company by an audience and then deliberately decreasing the perceived value of a security of a publicly traded company by presenting said narrative.

14) The method as in claim 13 further comprising
a) taking a short position in one or more securities of a publicly traded company;
b) generating one or more enhanced tickets to a live performance, wherein said one or more enhanced tickets entitle a bearer to a post-show privilege.

15) The method as in claim 14 further comprising
a) distributing at a live magic show one or more certificates of ownership to individuals bearing an enhanced ticket wherein said certificate of ownership evidences the bearer's ownership stake in a short position in a security of a publicly traded company;
b) realizing a profit in a short position in a security of a publicly traded company and distributing proceeds to individuals bearing certificates of ownership.

16) The method as in claim 13 further comprising
a) receiving by a computer a first set of company board member data comprising board member biographical information;
b) determining by a computer a social link between board members of a first company and board members of a second company.

17) The method as in claim 16 further comprising identifying by a computer a degree of separation between at least one of said one or more first publicly traded companies and a second publicly traded company.

18) The method as in claim 17 further comprising
a) receiving by a computer a manipulation factor from a user;
b) varying by a computer a display on a computer screen of a list of securities for publicly traded companies most likely to be successfully targeted for a short selling campaign based on said manipulation factor.

19) The method as in claim 13 further identifying by a computer a degree of separation between at least one of said one or more first publicly traded companies and a second publicly traded company.

20) The method as in claim 19 further comprising
a) receiving by a computer a manipulation factor from a user;
b) varying by a computer a display on a computer screen of a list of securities for publicly traded companies most likely to be successfully targeted for a short selling campaign based on said manipulation factor.
